(19) United States
(12) Patent Application Publication
(10) Pub. No.: US 2024/0003691 A1
(43) Pub. Date: Jan. 4, 2024

(54) SYSTEM AND METHOD FOR PROVIDING CUSTOMIZED UNIVERSITY ENTRANCE ROADMAP

(71) Applicant: LETITU CO., LTD., Seongnam-si (KR)

(72) Inventor: Da Hun LEE, Seoul (KR)

(21) Appl. No.: 17/812,983

(22) Filed: Jul. 15, 2022

(30) Foreign Application Priority Data
Jun. 29, 2022 (KR) 10-2022-0079535

(51) Int. Cl. G01C 21/34; G06Q 50/20

(52) U.S. Cl. CPC G01C 21/3415; G06Q 50/20; G01C 21/343

(57) ABSTRACT

A system for providing a customized university entrance roadmap according to an embodiment includes: a user data receiving unit for receiving user data input by a user through an application and including target universities and grades of the user; a roadmap generation unit for generating a customized roadmap for admission of the user to a university based on the received user data; and a roadmap management unit for updating the roadmap in real-time using an artificial intelligence model learned at regular intervals based on the user data, wherein the roadmap includes a curriculum including classes and tests appropriate to the user, and a scheduler for the curriculum.

### CROSS-REFERENCE TO RELATED APPLICATION

This application claims priority under 35 U.S.C § 119 to Korean Patent Application No. 10-2022-0079535 filed in the Korean Intellectual Property Office on Jun. 29, 2022, the entire contents of which is hereby incorporated by reference.

### FIELD OF THE INVENTION

The present invention relates to a system and method for providing a customized university entrance roadmap, and more particularly, to a system and method for providing a customized university entrance roadmap, which can provide a user-customized roadmap for entering a foreign university.

### BACKGROUND OF THE RELATED ART

There are about 4,000 universities in the United States, and documents required by each department or university and a college admission process thereof are different. Students who desire to enter the universities in the United States have difficulty in objectively and accurately grasping information on the many universities. In addition, monitoring the college admission process of each university updated every time requires a considerable time. Moreover, the process of students for filtering universities, in which their GPA, SAT, ACT and/or extracurricular activities are advantageously reflected, is quite complicated. In addition, it is practically impossible for the students to additionally consider by themselves their preferred conditions such as a region of school and tuition fee of the universities.

On the other hand, conventionally, in order to solve such problems, the students confirm the college admission process and prepare the documents of each university with the help of offline university admission consulting companies. However, there is a limit in that the number of students that can be managed by the university admission consulting companies is limited. In addition, the accuracy may be somewhat low since the consulting is conducted based on subjective opinions of admission consulting experts and constructed databases.

Therefore, for the students who desire to enter the universities in the United States, it needs to provide an online-based service for filtering universities by reflecting additional factors, objectively calculating an acceptance rate of each university based on university admission data, and providing consultation, curriculums, and schedulers for entering a desired university.

### SUMMARY OF THE INVENTION

Therefore, the present invention has been made in view of the above problems, and it is an object of the present invention to provide a system and method for providing a customized university entrance roadmap, which can provide a user with a user-customized roadmap for entering a university using a database and artificial intelligence.

Another object of the present invention is to provide a system and method for providing a customized university entrance roadmap, which can easily provide a user with a roadmap suitable for the user to enter a university through an application.

Another object of the present invention is to provide a system and method for providing a customized university entrance roadmap, which can provide a user with a curriculum and a scheduler needed for entering a university in real-time through an artificial intelligence model.

The technical problems to be solved by the present invention are not limited to the technical problems mentioned above, and unmentioned other technical problems can be clearly understood by those skilled in the art from the following description.

To accomplish the above objects, according to one aspect of the present invention, there is provided a system for providing a customized university entrance roadmap, the system including: a user data receiving unit for receiving user data input by a user through an application and related to admission of a user to a university; a roadmap generation unit for generating a customized roadmap for admission of the user to a university based on the received user data; and a roadmap management unit for updating the roadmap in real-time using an artificial intelligence model learned at regular intervals based on the user data, wherein the roadmap includes a curriculum including classes and tests appropriate to the user, and a scheduler for the curriculum.

According to another aspect of the present invention, there is provided a method of providing a customized university entrance roadmap, the method comprising the steps of: receiving user data input by a user through an application and including target universities and grades of the user; generating a customized roadmap for admission of the user to a university based on the received user data; and updating the roadmap in real-time using an artificial intelligence model learned at regular intervals based on the user data, wherein the roadmap includes a curriculum that selects classes and tests appropriate to the user, and a scheduler for the curriculum.

### BRIEF DESCRIPTION OF THE DRAWINGS

FIG. 1 is a view showing an overview of a system for providing a customized university entrance roadmap according to an embodiment of the present invention.

FIG. 2 is a block diagram showing the configuration of a system for providing a customized university entrance roadmap according to an embodiment of the present invention.

FIG. 3 is a block diagram showing the flow of a system for providing a customized university entrance roadmap according to an embodiment of the present invention.

FIG. 4 is a block diagram showing a roadmap generation unit according to an embodiment of the present invention.

FIG. 5 is a flowchart illustrating a method of providing a customized university entrance roadmap according to an embodiment of the present invention.

FIG. 6 is a flowchart illustrating a method of providing a customized university entrance roadmap according to an embodiment of the present invention.

FIG. 7 is a view showing an interface of a system for providing a customized university entrance roadmap according to an embodiment of the present invention.

### DETAILED DESCRIPTION OF THE PREFERRED EMBODIMENT

Hereinafter, the present invention will be described with reference to the accompanying drawings. However, the present invention may be implemented in several different forms, and thus is not limited to the embodiments described herein. In addition, in order to clearly explain the present invention in the drawings, parts unrelated to the description are omitted, and similar reference numerals are attached to similar parts throughout the specification.

Throughout the specification, when a part is “linked (connected, contacted, coupled)” to another part, it includes the cases of being “indirectly connected” with intervention of another member therebetween, as well as the cases of being “directly connected”. In addition, when a part “includes” a certain component, this means that other components may be further provided rather than excluding other components unless clearly stated otherwise.

The terms used in this specification are used only to describe specific embodiments, and are not intended to limit the present invention. Singular expressions include plural expressions unless the context clearly dictates otherwise. It should be understood that in the present specification, terms such as “comprise” or “have” are intended to specify existence of a feature, number, step, operation, component, part, or combination thereof described in the specification, not to preclude the possibility of existence or addition of one or more other features, numbers, steps, operations, components, parts, or combinations thereof.

In this specification, a “module” includes a unit configured of hardware, software, or firmware, and may be used to be interchanged with the terms such as logic, logic block, component, and circuit. The module may be an integrally configured component, a minimum unit performing one or more functions, or a part thereof. For example, the module may be configured as an application-specific integrated circuit (ASIC).

Hereinafter, embodiments of the present invention will be described in detail with reference to the accompanying drawings.

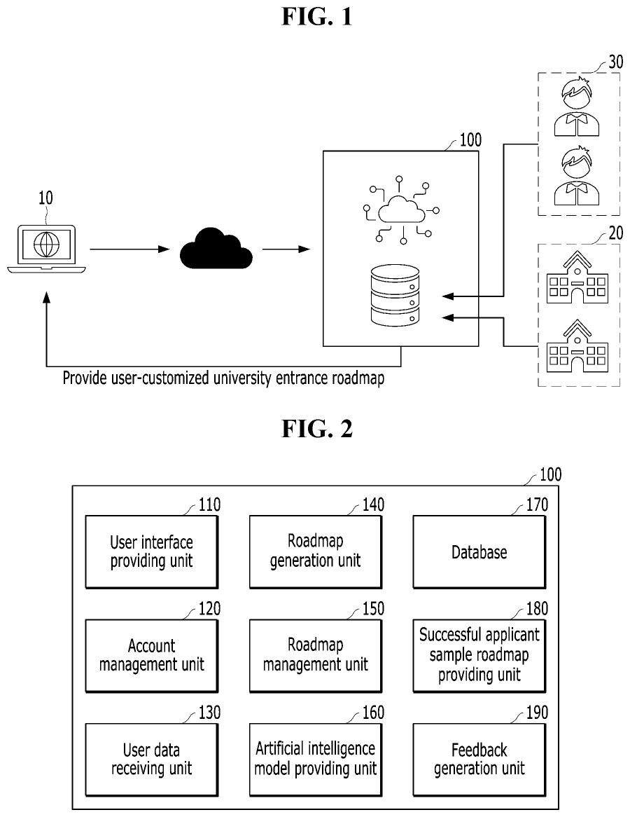

FIG. 1 is a view showing an overview of a system for providing a customized university entrance roadmap according to an embodiment of the present invention.

According to a network environment in which a system for providing customized university entrance roadmap may operate, a user terminal 10 may provide a user with an app or an application through which the user may be provided with a user-customized roadmap for entering a university. The user terminal 10 may provide the user with an app or an application capable of inputting user data. The user data may include information related to the user, i.e., needed for the user to enter a university. The user himself or herself may input the user data needed by the system for providing a customized university entrance roadmap related to a given user through an interface of the application. Here, the user data may include a target university and a department that the user desires to enter, a current grade level, various grades, and propensity and the like of the user.

The user terminal 10 may be a smart device equipped with a processor, memory, and communication functions, such as a smart phone, a tablet computer, a notebook computer, and a desktop computer. Alternatively, it may be a dedicated device, a kiosk, or point of care (POC) equipment having a display and an input function. The user terminal 10 may provide the user data input by the user to the customized university entrance roadmap providing system 100 through a wired or wireless network.

The customized university entrance roadmap providing system 100 may receive the user data input by the user from the user terminal 10. The customized university entrance roadmap providing system 100 may include an artificial intelligence model and a database.

The customized university entrance roadmap providing system 100 may include various kinds of university admission information 20 and successful applicant information 30 that will be provided to the user, as well as the user data, in the database. Here, the university admission information 20 may include all kinds of information needed for the user to enter a university, including admission requirements and admission schedules of the university. Here, the successful applicant information 30 may correspond to user data of various successful applicants who have successfully entered various universities. That is, the successful applicant information 30 may include information on the curriculum, grades, scheduler, and propensity of the successful applicants when they succeeded in entering a university.

The artificial intelligence model may be machine-learned to generate and manage a roadmap custom-tailored to the user data, i.e., customized for the user to enter a desired university. For example, the artificial intelligence model may be connected to the database including the user data, university admission information, and successful applicant information. That is, the artificial intelligence model may receive the user data, university admission information, and successful applicant information from the database, and generate a roadmap including a curriculum and a scheduler for entering a university, matching a target university, grades, propensity, and the like of the user, based on the information through machine learning.

The customized university entrance road map providing system 100 may generate a customized roadmap for the user to enter a university desired by the user using the database and the artificial intelligence model, and provide the roadmap to the user through the user terminal 10.

The customized university entrance roadmap providing system 100 may be implemented as a server that can be accessed by a plurality of users, a standalone device that provides a dedicated connection, or a cloud system.

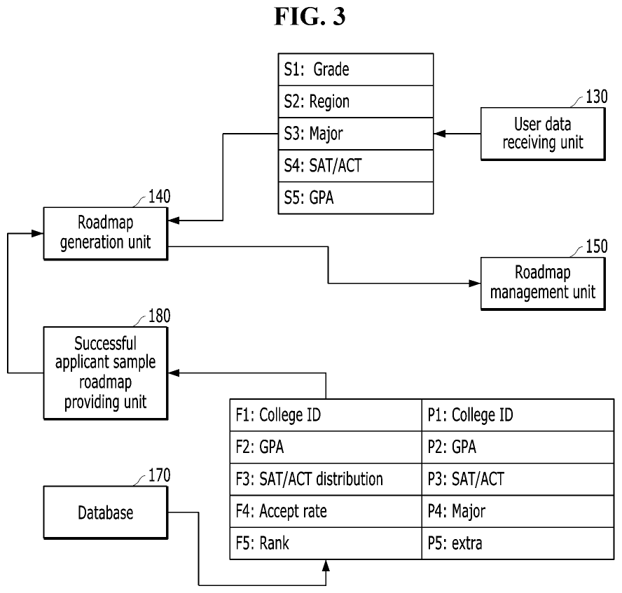

According to the configuration described above, the user may be provided with a roadmap needed for entering a university desired by the user, based on the user data input through the user terminal 10. In an embodiment, a user inputs user data at regular intervals, and the customized university entrance roadmap providing system 100 may update the generated user-customized roadmap by reflecting the updated user data in real-time, and provide the roadmap to the user. It will be described in more detail with reference to FIGS. 2 and 3.

FIG. 2 is a block diagram showing the configuration of a system for providing a customized university entrance roadmap according to an embodiment of the present invention. FIG. 3 is a block diagram showing the flow of a system for providing a customized university entrance roadmap according to an embodiment of the present invention.

Referring to FIG. 2, the customized university entrance roadmap providing system 100 includes a user interface providing unit 110, an account management unit 120, a user data receiving unit 130, a roadmap generation unit 140, a roadmap management unit 150, an artificial intelligence model providing unit 160, a database 170, a successful applicant sample roadmap providing unit 180, and a feedback generation unit 190.

The user interface providing unit 110 may provide a user interface to the user terminal 10. That is, the user interface providing unit 110 may provide the user terminal 10 with an interface through which a user may input user data through an application. The user interface providing unit 110 may also provide an interface through which the user may adjust some curriculums or schedulers of the roadmap provided to the user. In addition, the user interface providing unit 110 may provide a search interface through which roadmaps of other users or successful applicants may be searched. For example, the user interface providing unit 110 may provide a search interface so that a user may search for curriculums or schedulers of other users or successful applicants. Through the search interface, the user may also search for various kinds of information for entering a university, such as subjects to be taken, test schedules, and information on the university.

The account management unit 120 may manage an account of a user. That is, the account management unit 120 may specify a user. The account management unit 120 specifies a user through a user account, and the customized university entrance roadmap providing system 100 provides a customized roadmap to the user on the basis of the user data of the specified user. The account management unit 120 may be used when a customized roadmap is provided to the user.

The user data receiving unit 130 may receive user data from the user terminal 10. The user data receiving unit 130 may be connected to the database 170 and store the received user data in the database. The user data receiving unit 130 may access the user terminal 10 in real-time and update at regular intervals the user data continuously input by the user. In an embodiment, the user data receiving unit 130 may receive the user data at regular intervals through an interface provided to the user terminal 10 through the user interface providing unit 110.

The roadmap generation unit 140 may generate a customized roadmap for admission of the user to a university. The roadmap generation unit 140 may generate a roadmap including a curriculum and a scheduler suitable for the user based on the user data received through the user data receiving unit 130. Here, the roadmap may correspond to a guideline prepared to achieve a specific goal. That is, the roadmap generation unit 140 may generate a roadmap including an optimal guideline for the user to enter a target university based on the user data including the school, grade level, grades, and target university of the user. For example, the roadmap may provide the user with information on the subjects that the user should take in the future and the grades that the user should acquire, based on the information about the current grade level, currently acquired grades, and current subjects taken by the user. That is, the roadmap may provide the user with a curriculum of the subjects to be taken and grades to be acquired, and manage the schedule until the user enters the university through a scheduler according to the provided curriculum.

The roadmap generation unit 140 may generate a user-customized roadmap based on the user data and a sample roadmap of successful applicants having data matching the user. In an embodiment, the roadmap generation unit 140 may generate a user-customized roadmap through an artificial intelligence model machine-learned through the user data, university admission information, and successful applicant information.

The roadmap management unit 150 may update the roadmap in real-time using an artificial intelligence model machine-learned based on the user data. For example, the roadmap management unit 150 may update the roadmap in real-time using the artificial intelligence model received from the artificial intelligence model providing unit 160. The roadmap management unit 150 may update the roadmap in real-time based on the user data updated and received at regular intervals. That is, the roadmap management unit 150 may regenerate the roadmap by applying the data in real-time whenever data on the grade level, grades, and target university of the user changes.

The roadmap management unit 150 may provide a sample roadmap of successful applicants suitable for the user data using the artificial intelligence model whenever the user data changes. The roadmap management unit 150 may provide again a curriculum and a scheduler suitable for the user data using the artificial intelligence model whenever the user data changes. For example, when the sample roadmap of successful applicants matching the user changes according to update of the user data, the roadmap management unit 150 may change the roadmap of the user by reflecting the changed sample roadmap.

In an embodiment, the roadmap management unit 150 may compare the generated user-customized roadmap with the sample roadmap of matched successful applicants, and provide comparison information to the user. That is, the roadmap management unit 150 may provide the sample roadmap of successful applicants to the user, and allow the user to change the roadmap by himself or herself through the user interface.

The artificial intelligence model providing unit 160 may provide an artificial intelligence model machine-learned based on the user data as described above. The artificial intelligence model is not particularly limited, and may include all types of commercially available artificial intelligence models. For example, the artificial intelligence model may include a random forest model. The artificial intelligence model providing unit 160 may be connected to the database 170, the roadmap generation unit 140, and the roadmap management unit 150.

As described above with reference to FIG. 1, the database 170 may store various data needed for generating a user-customized university entrance roadmap. For example, the database 170 may store the user data, university admission information, and successful applicant information updated in real-time. In addition, the database 170 may store the generated user-customized roadmap in real-time. The database 170 may receive and store the user data received by the user data receiving unit 130.

The successful applicant sample roadmap providing unit 180 may be connected to the database. The successful applicant sample roadmap providing unit 180 may provide a sample roadmap of successful applicants to the user in response to a user's request. The sample roadmap of successful applicants may be a roadmap provided to the successful applicants in the days of an applicant. The successful applicant sample roadmap providing unit 180 may extract user data from the database, extract successful applicant information matching the user data, and provide the user with a sample roadmap of successful applicants. For example, the successful applicant sample roadmap providing unit 180 may provide the user with a sample roadmap of successful applicants matching the user's grades and propensity.

When the user's grades and propensity are updated, the successful applicant sample roadmap providing unit 180 may also change the matching sample roadmap of successful applicants. In an embodiment, the successful applicant sample roadmap providing unit 180 may be connected to the artificial intelligence model providing unit 160. The successful applicant sample roadmap providing unit 180 may analyze data on the change in the user's grades and curriculum through the artificial intelligence model, and provide the user with a sample roadmap of successful applicants of the same pattern or level of change.

The feedback generation unit 190 may generate and provide feedback to the user at regular intervals according to the curriculum of the user using the artificial intelligence model. The feedback generation unit 190 may generate feedback on the essay, test scores, and resume of the user included in the user data. Here, the feedback may be whether the user's test scores reach a level for entering a target university. The feedback may be whether the degree of achieving the user's scheduler reaches a level for entering a target university. The feedback generation unit 190 may provide the feedback by comparing the user's data with information on other users and successful applicants.

For example, the feedback generation unit 190 may generate feedback on the user's grades and adjust the curriculum and scheduler of the user together with the feedback. Alternatively, the feedback generation unit 190 may generate information on a recommended curriculum and/or a recommended class schedule that allows the user to adjust the curriculum and the scheduler, together with the feedback.

FIG. 3 is a block diagram showing the flow of roadmap generation and management of a system for providing a customized university entrance roadmap.

In FIG. 3, the user data receiving unit 130 may transmit user data including information on the user related to the grades (Grade, S1), residence region (Region, S2), major (Major, S3), SAT/ACT test scores (S4), and academic records (grade point average, GPA, S5) of the user to the roadmap generation unit 140. Here, it is obvious that the user data is not limited to S1 to S4 described above, and includes various kinds of information related to user's admission to a university.

The roadmap generation unit 140 may generate a roadmap based on the user data including various user information described above. The roadmap generation unit 140 may receive the successful applicant information including a sample roadmap of successful applicants through a successful applicant information providing unit 180, and generate a roadmap based thereon.

The database 170 may include university information and successful applicant information. That is, the university information may include information on the ranking of the university, SAT/ACT test score level accepted by the university, academic record level, provided departments, and the like. The successful applicant information may be provided for each university. The successful applicant information includes information on the SAT/ACT scores, academic records, accepted department, and the like of applicants admitted to a specific university. The information stored in the database 170 is not limited to the user data, university information, and successful applicant information, and may further include various kinds of information related to admission to a university, in addition to the user data, university information, and successful applicant information.

The successful applicant information providing unit 180 may receive university information and successful applicant information of each university. The successful applicant information providing unit 180 provides the successful applicant information of each university to the roadmap generation unit 140.

The roadmap management unit 150 may be connected to the roadmap generation unit 140. The roadmap management unit 150 may update in real-time the user-customized roadmap generated through the roadmap generation unit 140 according to update of the user data and/or the university information and successful applicant information. The details described in FIG. 2 in relation to FIG. 3 will be omitted.

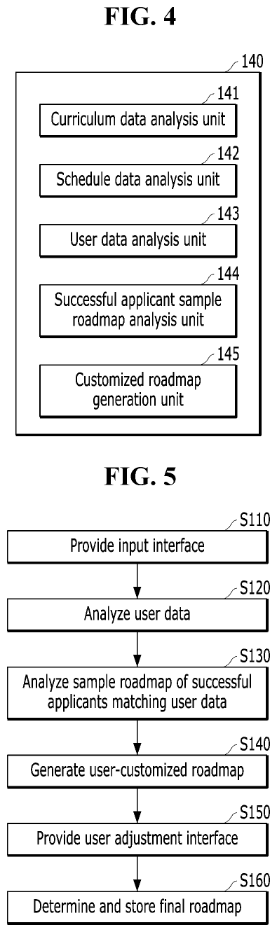

FIG. 4 is a block diagram showing a roadmap generation unit according to an embodiment of the present invention.

Referring to FIG. 4, the roadmap generation unit 140 includes a curriculum data analysis unit 141, a schedule data analysis unit 142, a user data analysis unit 143, a successful applicant sample roadmap analysis unit 144, and a customized roadmap generation unit 145.

The curriculum data analysis unit 141 may analyze university information and successful applicant information of a user's target university stored in the database. The curriculum data analysis unit 141 may extract both curriculums required by the university that the user desires to enter and curriculums of successful applicants admitted to the university, and generate a curriculum suitable for the user based on the user data.

The schedule data analysis unit 142 may analyze the current grade level, grade information, and currently provided class schedule information of the user based on the generated curriculum of the user. The schedule data analysis unit 142 may generate a schedule according to the curriculum of the user by analyzing the provided subjects and class schedules.

The user data analysis unit 143 may generate user data based on information such as a target university, grades, propensity, and the like of the user input by the user. For example, the user data analysis unit 143 may generate a user class in the process of generating the user data through user information input by the user. That is, the user data analysis unit 143 may assign a user class through the user data and classify the user into a group according to the class.

The successful applicant sample roadmap analysis unit 144 may analyze a sample roadmap of successful applicants matching the user. The successful applicant sample roadmap analysis unit 144 may extract a plurality of sample roadmaps of successful applicants matching the user data. The successful applicant sample roadmap analysis unit 144 may compare the extracted sample roadmaps of successful applicants with the roadmap of the user, and provide comparison information to the user. Here, the comparison information may include a difference or the like between the curriculums of the successful applicants and the curriculums of the sample roadmaps of successful applicants.

The customized roadmap generation unit 145 may generate a user-customized roadmap by integrating data generated through the curriculum data analysis unit 141, the schedule data analysis unit 142, the user data analysis unit 143, and the successful applicant sample roadmap analysis unit 144. The customized roadmap generation unit 145 may generate a roadmap based on the curriculum, the schedule of applying a university, and user data at the time of generating the roadmap, compare the generated roadmap with the sample roadmaps of successful applicants, and adjust the roadmap to finally generate a customized roadmap.

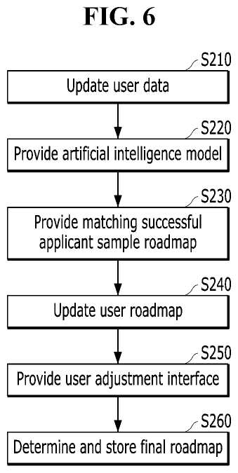

FIG. 5 is a flowchart illustrating a method of providing a customized university entrance roadmap according to an embodiment of the present invention. FIG. 6 is a flowchart illustrating a method of providing a customized university entrance roadmap according to an embodiment of the present invention. It will be described with reference to FIG. 2.

FIG. 5 is a flowchart illustrating a method of generating a roadmap by the roadmap generation unit 140. In FIG. 5, the user interface providing unit 110 may provide an input interface to the user (S110). The user inputs user information through the input interface.

The user data receiving unit 130 receives and analyzes user data including user information input by the user (S120). The user data receiving unit 130 may generate user data based on user information related to admission to a university.

The successful applicant sample roadmap providing unit 180 extracts and analyzes the sample roadmap of successful applicants matching the user data (S130). The roadmap generation unit 140 may generate a user-customized roadmap based on the user data with reference to the matched successful applicant sample roadmap (S140). When a customized roadmap is provided, the user may partly adjust the curriculum and scheduler included in the roadmap through the user interface. That is, the roadmap generation unit 140 may provide a user adjustment interface to the user while providing a roadmap (S150).

After the process of the adjustment interface is completed, the roadmap generation unit 140 may finally store the user-customized roadmap (S160). The finally generated roadmap may be updated by the roadmap management unit 150 whenever the user data is input again in connection with the user account.

FIG. 6 is a flowchart illustrating a method of updating the roadmap generated by the roadmap management unit 150. In FIG. 6, the user data receiving unit 130 may update the user data at regular intervals according to real-time input of the user (S210). The artificial intelligence model providing unit 160 may provide an artificial intelligence model machine-learned based on the university admission information, successful applicant information, and user data (S220). The artificial intelligence model learns whenever the user data is updated and provides the user data to the roadmap management unit 150, and the roadmap management unit 150 may regenerate the roadmap based on the updated user data (S240).

The roadmap management unit 150 updates the roadmap and provides an adjustment interface to the user so that the user may update the roadmap using the new roadmap (S250). The roadmap management unit 150 may update the roadmap and store the new roadmap as a final roadmap after user adjustment is completed (S260).

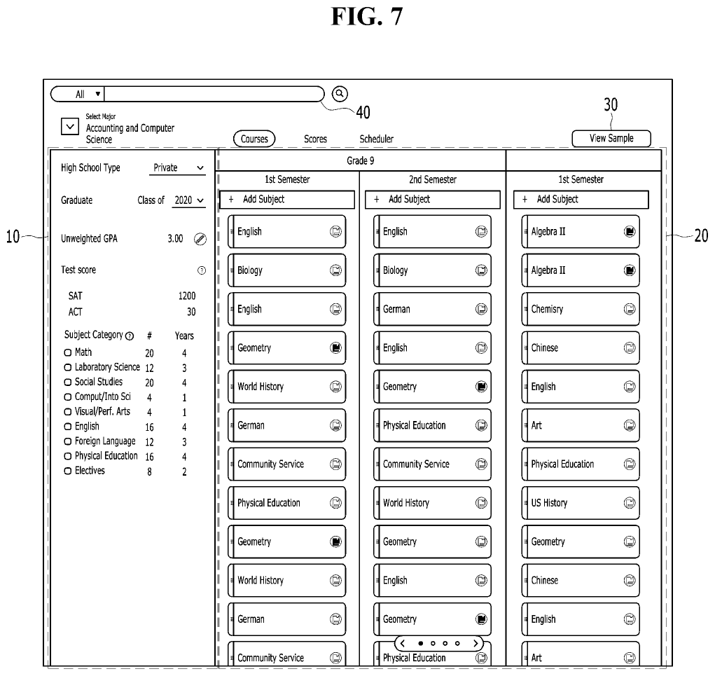

FIG. 7 is a view showing an interface of a system for providing a customized university entrance roadmap according to an embodiment of the present invention. In an embodiment, when the user selects the roadmap tab in the application, the system for providing a customized university entrance roadmap may provide the user with the interface of FIG. 7. The user may input user information into the user input window 10. For example, the user may input information on the academic records, school types, test scores, and current curriculum of the user.

A customized curriculum is provided to the user through the user curriculum window 20. Although the course tab that displays the user curriculum window 20 is selected currently, when the scheduler tab is selected, the user may be provided with a schedule table in the form of a calendar including test schedules and the like. Alternatively, when the score tab is selected, test scores of the user and test scores needed for entering a university may be displayed. The user curriculum window 20 displays the curriculum of the user included in the roadmap of the user. That is, subjects that the user should take in each grade and semester in order to enter a university may be generated. The successful applicant sample roadmap selection tab 30 may provide a matching sample roadmap of successful applicants to the user. The user may select a sample roadmap of successful applicants and apply it to the curriculum of his or her own roadmap. The search interface 40 allows the user to search for roadmap information of other users or successful applicants. Through the search interface 40, the user may search for subjects or a class schedule that he or she desires to add to the curriculum. FIG. 7 only shows an interface according to an embodiment, and the interface screen is not particularly limited thereto, and the interface may be provided in various forms.

According to an embodiment of the present invention, a system and method for providing a customized university entrance roadmap may provide a user with a user-customized roadmap for entering a university using a database and an artificial intelligence.

The system and method for providing a customized university entrance roadmap according to an embodiment may easily provide a user with an optimal roadmap for entering a university through an application.

The system and method for providing a customized university entrance roadmap according to an embodiment may provide in real-time a user with a curriculum and a scheduler needed for entering a university through an artificial intelligence model.

It should be understood that the effects of the present invention are not limited to the effects described above, and include all effects that can be inferred from the configuration of the invention described in the detailed description or claims of the present invention.

The method according to an embodiment of the present invention described above may be implemented in the form of program instructions that can be executed through various computer components, and recorded in a computer-readable recording medium. The computer-readable recording medium may include program instructions, data files, data structures, and the like alone or in combination. The program instructions recorded in the computer-readable recording medium may be specially designed and configured for the embodiments of the present invention, or may be known and available to those skilled in the art of computer software field. The computer-readable recording medium includes hardware configured to store and execute program instructions, such as a magnetic recording medium including a hard disk, a floppy disk, and a magnetic tape, an optical recording medium including a CD-ROM and a DVD, a magneto-optical medium including a floptical disk, ROM, RAM, flash memory, and the like. The program instructions include machine codes generated by a compiler, and high-level language codes that can be executed in a computer using an interpreter. The hardware may be configured to operate by one or more software modules to process the method according to the present invention, and vice versa.

The method according to an embodiment of the present invention may be executed in an electronic device in the form of a program instruction. The electronic device includes a portable communication device such as a smart phone, a smart pad or the like, a computer device, a portable multimedia device, a portable medical device, a camera, a wearable device, and a home appliance device.

The method according to an embodiment of the present invention may be provided to be included in a computer program product. The computer program product is a merchandise and may be traded between sellers and buyers. The computer program product may be distributed in the form of a device-readable recording medium or online through an application store. In the case of online distribution, at least some of the computer program products may be temporarily stored or temporarily generated in a storage medium such as a memory of a manufacturer server, an application store server, or a relay server.

Each of the components, for example, a module or a program, according to an embodiment of the present invention may be configured as a single sub-component or a plurality of sub-components, and some of the sub-components may be omitted, or other sub-components may be further included. Some components (modules or programs) may be integrated into a single entity to perform the same or similar functions performed by each corresponding component before the integration. Operations performed by the modules, programs, or other components according to an embodiment of the present invention may be executed sequentially, in parallel, repetitively, or heuristically, or at least some of the operations may be executed in a different order or omitted, or other operations may be added.

The description of the present invention described above is for illustrative purposes, and those skilled in the art may understand that it can be easily modified into other specific forms without changing the technical spirit or essential features of the present invention. Therefore, it should be understood that the embodiments described above are illustrative in all respects and not restrictive. For example, each component described as a single type may be implemented in a distributed form, and components described as distributed may also be implemented in a combined form likewise.

The scope of the present invention is indicated by the following claims, and all changes or modifications derived from the meaning and scope of the claims and their equivalents should be construed as being included in the scope of the present invention.

### DESCRIPTION OF SYMBOLS

100: System for providing customized university entrance roadmap
10: User terminal
110: User interface providing unit
120: Account management unit
130: User data receiving unit
140: Roadmap generation unit
150: Roadmap management unit
160: Artificial intelligence model providing unit
170: Database
180: Successful applicant sample roadmap providing unit
190: Feedback generation unit

What is claimed is:

1. A system for providing a customized university entrance roadmap, the system comprising:
a user data receiving unit for receiving user data input by a user through an application and related to admission to a university;
a roadmap generation unit for generating a customized roadmap for admission of the user to a university based on the received user data; and
a roadmap management unit for updating the roadmap in real-time using an artificial intelligence model machine-learned based on the user data, wherein
the roadmap includes a curriculum including classes and tests, and a scheduler for the curriculum.

2. The system according to claim 1, further comprising a database for storing university information, successful applicant information, and the user data updated in real-time, wherein the database stores in real-time the customized roadmap generated by the roadmap generation unit.

3. The system according to claim 2, wherein the roadmap generation unit extracts a sample roadmap of successful applicants having data matching the user data from the database, and provides the sample roadmap to the user.

4. The system according to claim 3, wherein the roadmap generation unit generates a customized roadmap of the user based on the sample roadmap of successful applicants.

5. The system according to claim 3, wherein the roadmap management unit compares the generated roadmap with the sample roadmap of successful applicants, and provides comparison information to the user, and the system further includes an interface providing unit for providing the user with an interface for adjusting the roadmap.

6. The system according to claim 5, wherein the interface providing unit provides a search interface for searching for curriculums and schedulers of other users or successful applicants.

7. The system according to claim 6, further comprising a feedback generation unit for providing feedback at regular intervals according to the curriculum of the user using the artificial intelligence model.

8. A method of providing a customized university entrance roadmap, the method comprising the steps of:
receiving user data input by a user through an application and related to admission of the user to a university;
generating a customized roadmap for admission of the user to a university based on the received user data; and
updating the roadmap in real-time using an artificial intelligence model learned at regular intervals based on the user data, wherein
the roadmap includes a curriculum that selects classes and tests appropriate to the user, and a scheduler for the curriculum.

9. The method according to claim 8, wherein the step of generating a customized roadmap includes the step of providing the user with a sample roadmap of successful applicants having data matching the user data.

10. The method according to claim 9, wherein the step of generating a customized roadmap further includes the step of providing comparison information of comparing the sample roadmap of successful applicants with the customized roadmap of the user, and providing the user with an interface for adjusting the customized roadmap.

11. The method according to claim 10, wherein the step of receiving user data includes the step of receiving in real-time the user data varying at regular intervals, and the step of updating the roadmap further includes the step of providing the user with an update result of the roadmap output by the artificial intelligence model based on a change in the user data received in real-time.

12. The method according to claim 10, wherein the step of providing an interface includes the step of providing a search interface for searching for curriculums and schedulers of other users or successful applicants.

13. The method according to claim 8, wherein the step of updating the roadmap includes the step of providing feedback on test scores and schedule management of the user according to the curriculum of the user.
